(19) United States
(12) Patent Application Publication
(10) Pub. No.: US 2022/0336813 A1
(43) Pub. Date: Oct. 20, 2022

(54) THERMALLY STABLE POLYMER BINDERS FOR LITHIUM-ION BATTERY ANODES

(71) Applicant: Applied Materials, Inc., Santa Clara, CA (US)

(72) Inventors: SUBRAMANYA P. HERLE, Mountain View, CA (US); Gao LIU, Piedmont, CA (US); Jie GUAN, San Jose, CA (US); James CUSHING, Santa Clara, CA (US); Ajey M. JOSHI, San Jose, CA (US); Tianyu ZHU, El Cerrito, CA (US); Chen FANG, Kensington, CA (US); Thanh-Nhan TRAN, Berkeley, CA (US)

(21) Appl. No.: 17/659,302

(22) Filed: Apr. 14, 2022

Related U.S. Application Data
(60) Provisional application No. 63/175,735, filed on Apr. 16, 2021.

(51) Int. Cl. H01M 4/62; H01M 4/134; H01M 4/133; H01M 4/04; C08G 73/10

(52) U.S. Cl. CPC H01M 4/622; H01M 4/134; H01M 4/133; H01M 4/0404; C08G 73/1046; H01M 2004/027

(57) ABSTRACT

Polyimide binders and their polyamic precursors to be used for forming electrode structures are provided. The designed polyamic binder precursors are water-soluble, and the resulting polyimide binders are mechanically strong, electrochemically and thermally stable. The properties of polyimide binders have led to significant improvement in electrode compatibility towards new manufactural processes.

### CROSS-REFERENCE TO RELATED APPLICATIONS

This application claims benefit of U.S. Provisional Patent Application No. 63/175,735, filed Apr. 16, 2021, which is herein incorporated by reference in its entirety.

### STATEMENT OF GOVERNMENTAL SUPPORT

The invention was made with government support under Contract No. DE-EE0009093 awarded by the U.S. Department of Energy. The government has certain rights in the invention

### BACKGROUND

### Field

The present disclosure generally relates to lithium-ion batteries, and more specifically to polymer binders and composite anodes formed from the polymer binders.

### Description of the Related Art

Synthetic polymer binders have been widely utilized in lithium-ion batteries to hold electrode components, for example, active material, carbon black, etc., together. A range of synthetic or natural based polymers have been developed as binder materials, such as polyvinylidene fluoride (PVDF), polyethylene oxide (PEO), polyacrylic acid (PAA), and polyvinyl alcohol (PVA), among others. The thermomechanical, electrochemical, and adhesion properties of the aforementioned polymers are generally determined by their chemical structures and functionalities. Many of these polymers are either mechanically weak or thermally unstable at higher temperatures, which limit their compatibility with new manufacturing processes. As a result, most conventional polymer binders are not suitable for new high temperature manufacturing processes.

Thus, there is a need for improved polymer binders and electrodes formed from the same.

### SUMMARY

The present disclosure generally relates to energy storage devices, and more specifically to polymer binders and composite anodes formed from the polymer binders.

In one aspect, a polymer binder including amic acid groups and imide functionalities in a backbone of the polymer is provided.

Implementations may include one or more of the following. The amic acid groups can be partially or fully reacted with lithium salts for water or organic based process. The amic acid groups can be partially or fully converted to imide by a thermal process. Conversion of polyamic to polyimide can happen concurrently with a high temperature processes. The polymer binder is flexible and strong. The polymer binder is water-soluble. The polymer binder is a lithiated polyimide binder.

In another aspect, a method of using and processing polyamic and polyimide binder for anodes is provided. The method further includes fabricating a lithium-ion battery using the composite electrode.

Implementations may include one or more of the following. The method comprises thermally treating a polymer binder for imidization, wherein the polymer binder is used as a binder for composite electrodes. The polymer binder includes amic acid groups and imide functionalities in a backbone of the polymer. The amic acid groups can be partially or fully reacted with lithium salts for water or organic based process. The amic acid groups can be partially or fully converted to imide by a thermal process. Conversion of polyamic to polyimide can happen concurrently with a high temperature processes. The polymer binder is flexible and strong. The polymer binder is water-soluble. The polymer binder is a lithiated polyimide binder.

In yet another aspect, a composite electrode is provided. The composite electrode includes an active material and a water-soluble polymer binder.

Implementations may include one or more of the following. The composite electrode is tolerant to high temperature and mechanical bending. The thickness of the composite electrode is from about 1 μm to 100 μm. The polymer binder includes amic acid groups and imide functionalities in a backbone of the polymer. The amic acid groups can be partially or fully reacted with lithium salts for water or organic based process. The amic acid groups can be partially or fully converted to imide by a thermal process. Conversion of polyamic to polyimide can happen concurrently with a high temperature processes. The polymer binder is flexible and strong. The polymer binder is water-soluble. The polymer binder is a lithiated polyimide binder.

In yet another aspect, a method of manufacturing an electrode is provided. The method includes exposing a polyamic precursor to a high temperature lithium deposition process to convert the polyamic precursor to a polyimide binder and form a composite electrode including the polyimide binder and lithium.

Implementations may include one or more of the following. The composite electrode further includes an anode material comprising silicon and/or carbon. The polyamic precursor is water-soluble. The polyamic precursor is selected from at least one of:

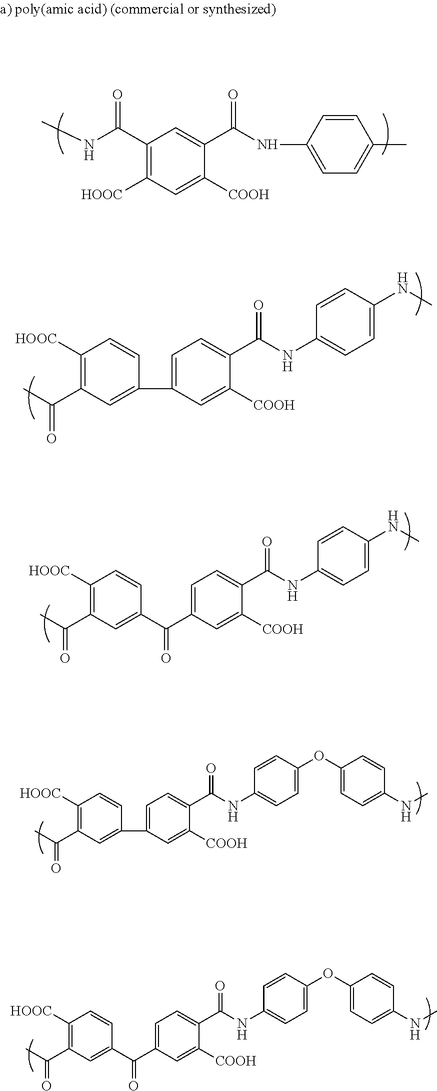

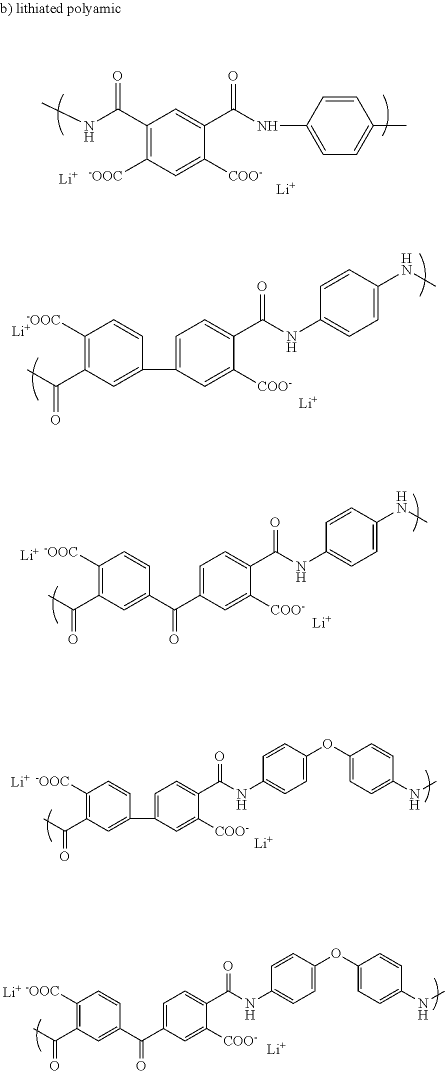

The polyimide binder comprises a lithiated polyimide selected from at least one of:

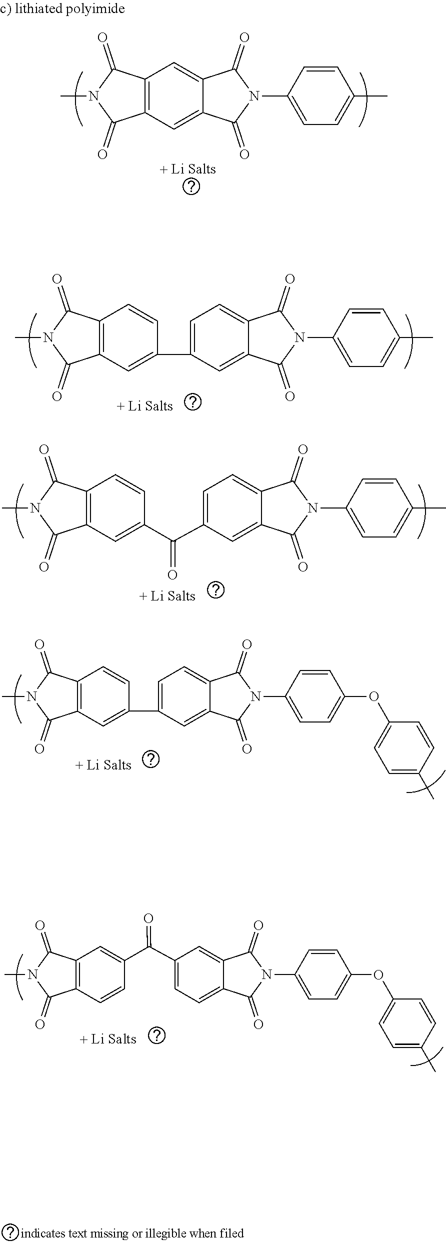

In yet another aspect, a method of forming an electrode structure is provided. The method includes forming a slurry including a polyamic precursor and one or more anode active materials.

Implementations may include one or more of the following. The method further includes depositing a thin film of the slurry on a substrate and exposing the thin film and substrate to thermal processing to form the electrode structure. The thermal processing is selected from a thermal drying process, a vapor deposition process, or a combination thereof. The depositing a thin film includes a slot-die coating process. The one or more anode active materials are selected from SiOx, silicon, graphite, or a combination thereof. The slurry further comprises a conductive additive selected from natural graphite, artificial graphite, carbon black, acetylene black, ketjen black, a carbon fiber, or a combination of. The thermal drying process evaporates the water from the electrode structure. The electrode structure is combined with a positive electrode structure, a first current collector contacting the positive electrode structure, a second current collector contacting the electrode structure and a separator positioned between the positive electrode structure and the negative electrode structure. The polyamic precursor is lithiated. The polyamic precursor is water-soluble.

### BRIEF DESCRIPTION OF THE DRAWINGS

The patent or application file contains at least one drawing executed in color. Copies of this patent or patent application publication with color drawings(s) will be provided by the Office upon request and payment of the necessary fee.

So that the manner in which the above recited features of the present disclosure can be understood in detail, a more particular description of the implementations, briefly summarized above, may be had by reference to implementations, some of which are illustrated in the appended drawings. It is to be noted, however, that the appended drawings illustrate only typical implementations of this disclosure and are therefore not to be considered limiting of its scope, for the disclosure may admit to other equally effective implementations.

FIG. 1A illustrates a cross-sectional view of one example of a lithium-ion energy storage device incorporating an electrode structure formed according to one or more implementations described herein.

FIG. 1B illustrates a cross-sectional view of one example of a dual-sided electrode structure formed according to one or more implementations described herein.

FIG. 2 illustrates a process flow chart summarizing one implementation of a method for forming an electrode structure according to one or more implementations of the present disclosure.

FIG. 3A illustrates chemical structures of polyamic acid according to one or more implementations of the present disclosure.

FIG. 3B illustrates chemical structures of water-soluble polyamic precursors according to one or more implementations of the present disclosure.

FIG. 3C illustrates chemical structures of a resulting polyimide with lithium salts according to one or more implementations of the present disclosure.

FIG. 4 illustrates an example of synthesizing water-soluble polyamic precursor and polyimide binder according to one or more implementations of the present disclosure.

FIG. 5 illustrates differential scanning calorimetry (DSC) curves for (a) the imidization process of a water-soluble polyamic precursor and (b) the resulting polyimide according to one or more implementations of the present disclosure.

FIG. 6 illustrates thermogravimetric analysis (TGA) of the polyamic precursor and resulting polyimide binder according to one or more implementations of the present disclosure.

FIG. 7 illustrates a Fourier Transform Infrared Spectroscopy (FT-IR) analysis of the polyamic precursor and resulting polyimide binder according to one or more implementations of the present disclosure.

FIG. 8A illustrates a cyclic voltammetry (CV) plot of the polyamic precursor according to one or more implementations of the present disclosure.

FIG. 8B illustrates a cyclic voltammetry (CV) plot of the resulting polyimide binder according to one or more implementations of the present disclosure.

FIG. 9 illustrates a plot of X-ray diffraction (XRD) curves of polyimide films formed according to one or more implementations of the present disclosure.

FIG. 10A illustrates a scanning electron microscope (SEM) image of a graphite composite electrode with lithiated polyimide binder formed according to one or more implementations of the present disclosure.

FIG. 10B illustrates an SEM image of a SiOx composite electrode with lithiated polyimide binder formed according to one or more implementations of the present disclosure.

FIG. 11A illustrates an SEM image of a SiOₓ composite electrode with lithium polyacrylic binder before bending.

FIG. 11B illustrates an SEM image of a SiOₓ composite electrode with lithium polyacrylic binder after bending.

FIG. 11C illustrates an SEM image of a SiOₓ composite electrode with polyimide binder before bending according to one or more implementations of the present disclosure.

FIG. 11D illustrates SEM images of a SiOₓ composite electrode with polyimide binder after bending according to one or more implementations of the present disclosure.

FIG. 12A illustrates a plot of cycling performance of graphite electrodes formed with a lithiated polyamic or a lithiated polyimide binder according to one or more implementations of the present disclosure.

FIG. 12B illustrates a plot of cycling performance of graphite electrodes formed with a lithiated polyamic or a lithiated polyimide binder according to one or more implementations of the present disclosure.

FIG. 13A illustrates a plot of cycling performance of SiOx electrodes formed with a lithiated polyamic or a lithiated polyimide binder.

FIG. 13B illustrates a plot of cycling performance of graphite electrodes formed with a lithiated polyamic or a lithiated polyimide binder.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

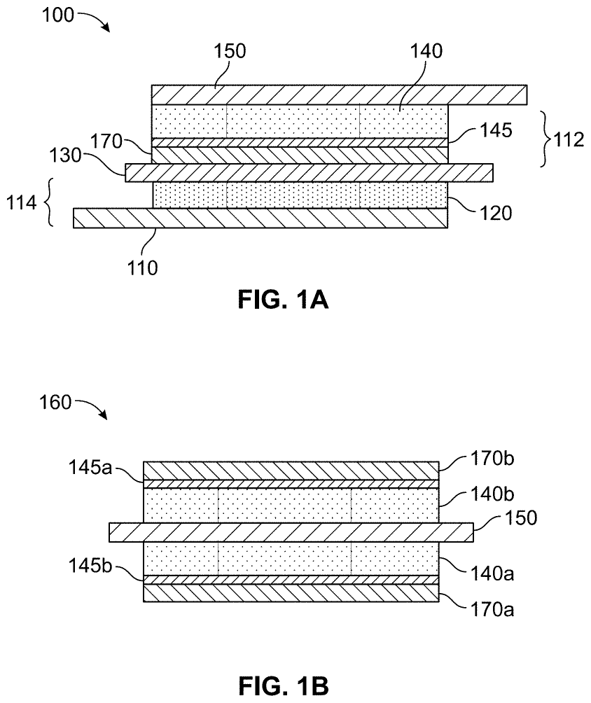

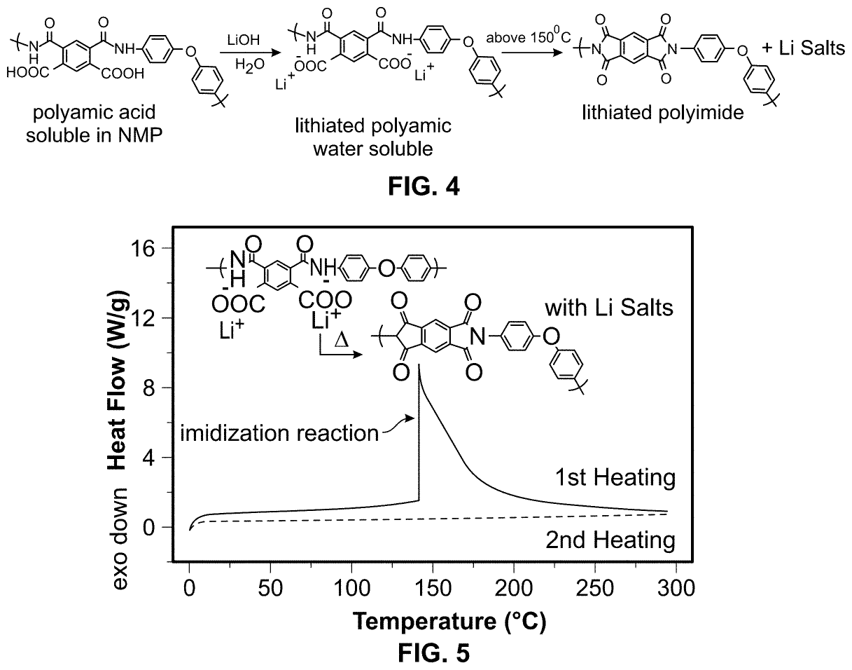

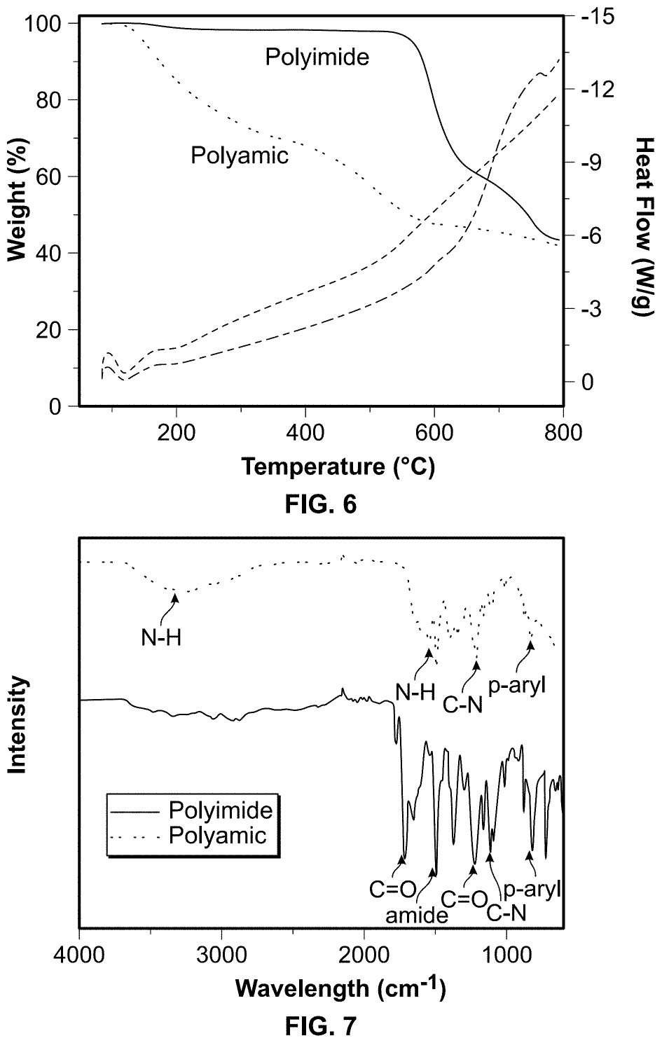

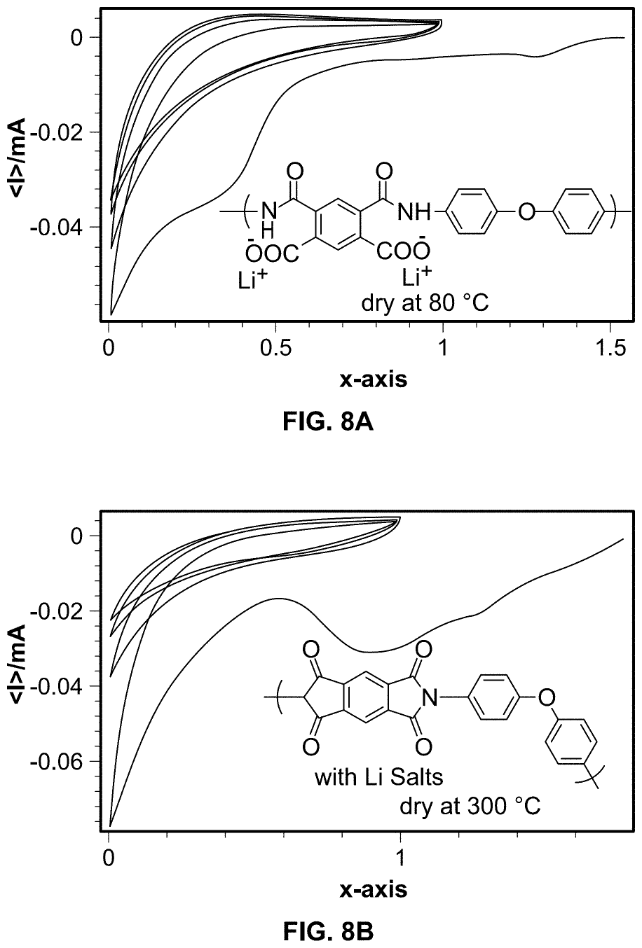

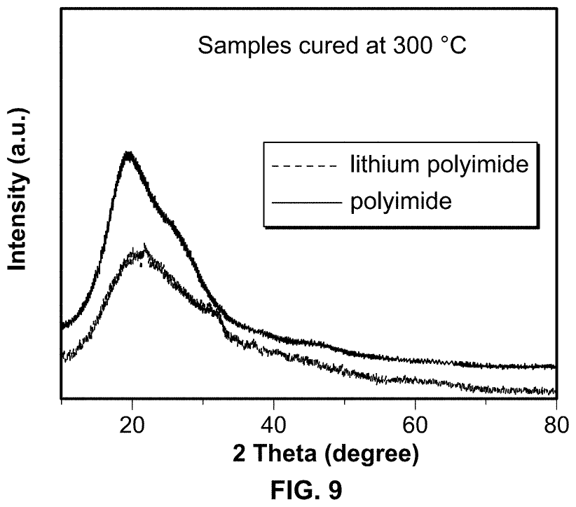

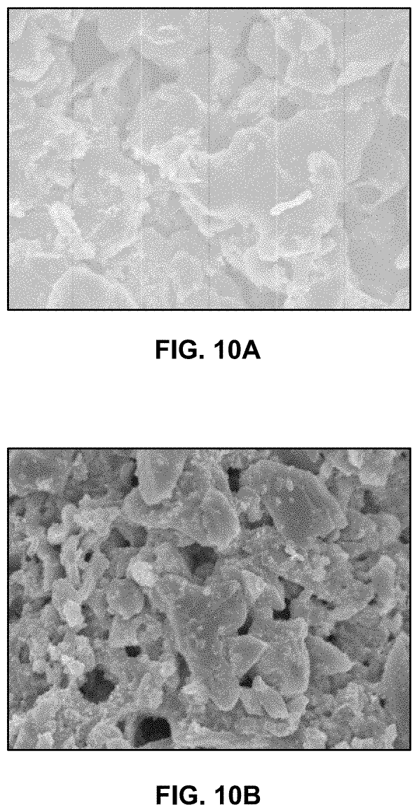

The following disclosure describes water-soluble precursors for forming binder materials, pre-lithiated composite electrodes including the binder materials, and methods of forming the same. Certain details are set forth in the following description and in FIGS. 1A-13B to provide a thorough understanding of various implementations of the disclosure. Other details describing well-known structures and systems often associated with forming electrodes and binder materials are not set forth in the following disclosure to avoid unnecessarily obscuring the description of the various implementations.

Many of the details, dimensions, angles and other features shown in the Figures are merely illustrative of particular implementations. Accordingly, other implementations can have other details, components, dimensions, angles and features without departing from the spirit or scope of the present disclosure. In addition, further implementations of the disclosure can be practiced without several of the details described below.

Synthetic polymer binders have been utilized in lithium-ion batteries to hold electrode components (active material, carbon black, etc.) together. A range of synthetic or natural based polymers has been developed as binder materials, for example, polyvinylidene fluoride (PVDF), polyethylene oxide (PEO), polyacrylic acid (PAA), and polyvinyl alcohol (PVA). The thermomechanical, electrochemical and adhesion properties of these polymers are mostly determined by their chemical structures and functionalities. Many of the known binder materials are either mechanically weak or thermally unstable, which limit their compatibility with new manufacturing processes. For example, polyacrylic acid and its derivatives are frequently used as anode binder for silicon-based anodes. However, their thermal decomposition temperature is low, and this class of polymers becomes extremely brittle upon drying (<50 ppm). For instance, dehydration from the carboxylic acid groups (in polyacrylic acid) occurs at approximately 200° C., and decarboxylation occurs at approximately 250° C. Further chain scission occurs at a higher temperature causing poor mechanical and electrochemical properties. In addition, water is formed during degradation of the binder, which is unfavorable during pre-lithiation processes (2H₂O+2Li=2LiOH+H₂). Thus, new manufacturing processes, for example, high temperature pre-lithiation processes, make most conventional polymer binders less preferred for their thermal, chemical or electrochemical stability.

Polyimide represents a class of synthetic polymer that demonstrates good mechanical properties, exceptional thermal stability, and good adhesive properties. Polyimide derivatives have recently been reported for potential application as electrode binders. However, one weakness of polyimide derivatives is their solubility. The processing of polyimide compounds is mostly based on organic solvents, for example, dimethylformamide and chloroform, which is not favorable for large scale and eco-friendly manufacturing processes.

Implementations of the present disclosure include a water-soluble polyamic precursor design, which can function as both a synthetic binder and a precursor for polyimide binders with great thermal stability and mechanical flexibility. Furthermore, these polyimide binders can also accommodate new manufacturing processes that entail high thermal stability and mechanical flexibility. Benefiting from the unique properties of the class of polymers described herein, the resulting composite electrodes can be directly applied in high temperature processes and in-situ converted to highly stable polyimide by an endo-thermal reaction.

Implementations of the present disclosure, include polyamic binders and precursors of polyamic binders that can support water-based electrode fabrication and in-situ convert (partially or fully depending upon the manufacturing temperature) to polyimides during the high temperature manufacturing process. For example, a prelithiation process by vapor deposition of lithium generates heat, which can be taken by the polyamic precursor to form (or partially form) thermally stable polyimide in composite electrodes.

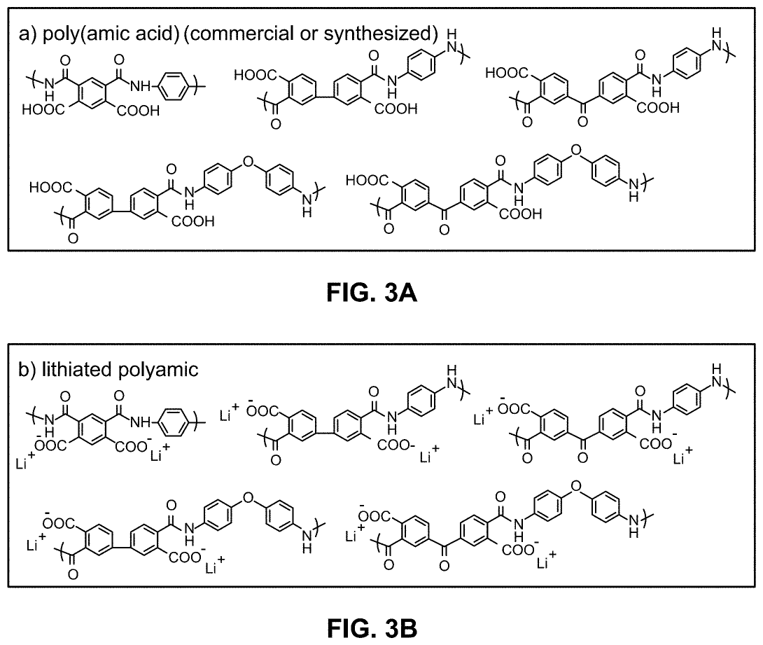

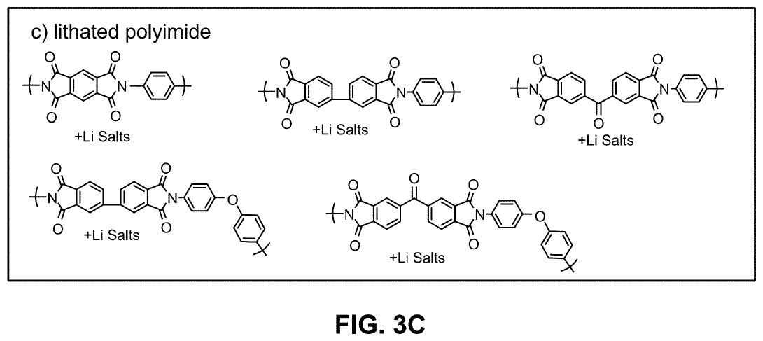

The inventors have demonstrated the synthesis and process of water-soluble polyamic binders (from commercial or synthesized polyamic acid) and the corresponding imidization products (polyimide), as well as their structural analysis, electrode fabrication and electrochemical performance in lithium-ion batteries. FIGS. 3A-3C illustrate general implementations of the present disclosure including polyamic acid, water-soluble polyamic precursor, polyimide products.

In some implementations of the present disclosure, the polyamics described herein can be partially or fully converted to polyimide with exceptional stability by taking the heating during processing.

In some implementations, the polymer compositions described herein include homopolymers, copolymers and polymer blends. The polymers described herein have or include polyamic and/or polyimide moieties at the backbones.

In some implementations of the present disclosure, polyimide binders and their application in battery fabrication are provided to achieve improved chemical, mechanical and electrochemical performance.

In some implementations, polyimide binders and their application in battery fabrication are provided to allow improved compatibility towards manufacturing processes.

In some implementations, the polyimide binders described herein are believed to be compatible with cylindrical cells, coin cells, pouch cells, among others.

In some implementations, the polymer binders described herein also works for other metal-ion or metal-air batteries including but not limited to metals such as lithium, potassium, and sodium.

FIG. 1A illustrates a cross-sectional view of one example of a lithium-ion energy storage device 100 incorporating an electrode structure formed according to one or more implementations described herein. The lithium-ion energy storage device 100 has a positive current collector 110, a positive electrode 120 or cathode, a separator 130, a negative electrode 140 or anode, a lithium metal film 145 or pre-lithiation film, with an optional surface protection film 170 formed thereon, and a negative current collector 150. The lithium-ion energy storage device can include a negative electrode structure 112 and a positive electrode structure 114 separated by the separator 130. At least one of the negative electrode structure 112 and the positive electrode structure 114 can include a composite electrode formed from binder materials according to implementations described herein. The negative electrode structure 112 can include the negative electrode 140, the lithium metal film 145, with the optional surface protection film 170 formed thereon, and the negative current collector 150. The positive electrode structure 114 can include the positive current collector 110, the positive electrode 120, and optionally a lithium metal film or pre-lithiation film formed on the positive electrode 120. Note in FIG. 1 that the current collectors are shown to extend beyond the stack, although it is not necessary for the current collectors to extend beyond the stack, the portions extending beyond the stack may be used as tabs.

The current collectors 110, 150, on positive electrode 120 and negative electrode 140, respectively, can be identical or different electronic conductors. Examples of metals that the current collectors 110, 150 may be comprised of include aluminum (Al), copper (Cu), zinc (Zn), nickel (Ni), cobalt (Co), tin (Sn), silicon (Si), manganese (Mn), magnesium (Mg), alloys thereof, and combinations thereof. In one example, at least one of the current collectors 110, 150 is perforated. Furthermore, current collectors may be of any form factor (e.g., metallic foil, sheet, or plate), shape and micro/macro structure. Generally, in prismatic cells, tabs are formed of the same material as the current collector and may be formed during fabrication of the stack, or added later. All components except current collectors 110 and 150 can contain lithium-ion electrolytes.

The negative electrode 140 or anode may be any material compatible with the positive electrode 120. The negative electrode 140 may have an energy capacity greater than or equal to 372 mAh/g, preferably 700 mAh/g, and most preferably 1000 mAh/g. The negative electrode 140 may be constructed from carbon, graphite, silicon, silicon oxide, silicon-containing graphite, lithium, lithium metal foil, a lithium alloy foil (e.g. lithium aluminum alloys, lithium silver alloys, etc.), nickel, copper, silver, tin, indium, gallium, tin, bismuth, niobium, molybdenum, tungsten, chromium, titanium, lithium titanate, silicon, oxides thereof, composites thereof, or combinations thereof. The negative electrode 140 can be a composite anode including any of the aforementioned materials and a binder material as described herein. The binder material can be formed according to implementations described herein. The composite anode can further include conductive materials, for example, carbon black or acetylene black, and optional solvents. In some implementations, the composite anode is made by mixing particles of the aforementioned materials in a solution or slurry form with, for example, carbon black, a binder material as described herein, and a solvent. The composite anode can be casted using traditional slurry-based methods, for example, slot-die coating and/or doctor blade coating techniques. The conductive additive can be selected from the group of graphite, graphene hard carbon, carbon black, carbon coated silicon, or a combination thereof. The binder material can be any of the water-soluble polyamic binder materials and/or their corresponding imidization products as described herein.

In some implementations, the lithium metal film 145 or pre-lithiation film can be formed on the negative electrode 140. The lithium metal film 145 may be formed according to the implementations described herein. In some implementations, the lithium metal film 145 can be a composite film including a lithium source and binder material as described herein. In some implementations, the negative electrode 140 is a silicon graphite or graphite composite anode with the lithium metal film 145 formed thereon. The lithium metal film 145 replenishes lithium lost from first cycle capacity loss of the negative electrode 140. The lithium metal film 145 may be a thin lithium metal film (e.g., 20 microns or less, from about 1 micron to about 20 microns, from about 2 microns to about 10 microns). The lithium metal film 145 can be deposited using vapor deposition techniques. For example, the lithium metal film 145 can be deposited by thermal evaporation techniques or electron beam evaporation techniques. The lithium metal film 145 can be deposited in a vacuum environment. In some implementations, the heat produced during deposition of the lithium metal film can partially or fully convert the water-soluble polyamic binder to a polyimide to form the composite anode structure. It should be understood that although the lithium metal film 145 is shown in FIG. 1A and FIG. 1B, that in some implementations, the lithium metal film is either partially or completely intercalated into the electrode structure.

In some implementations, a surface protection film 170 is formed on the lithium metal film 145. The surface protection film 170 can be an ion-conducting polymer. The surface protection film 170 can be porous. In some implementations, the surface protection film 170 has nano-pores. In one implementation, the surface protection film 170 has a plurality of nano-pores that are sized to have an average pore size or diameter less than about 10 nanometers (e.g., from about 1 nanometer to about 10 nanometers; from about 3 nanometers to about 5 nanometers). In another implementation, the surface protection film 170 has a plurality of nano-pores that are sized to have an average pore size or diameter less than about 5 nanometers. In one implementation, the surface protection film 170 has a plurality of nano-pores having a diameter ranging from about 1 nanometer to about 20 nanometers (e.g., from about 2 nanometers to about 15 nanometers; or from about 5 nanometers to about 10 nanometers).

The surface protection film 170 may be a coating or a discrete layer, either having a thickness in the range of 1 nanometer to 2,000 nanometers (e.g., in the range of 10 nanometers to 600 nanometers; in the range of 50 nanometers to 200 nanometers; in the range of 100 nanometers to 150 nanometers). The surface protection film 170 may be a discrete membrane having a thickness in the range of 5 microns to 50 microns (e.g., in the range of 6 microns to 25 microns). In some implementations, where the surface protection film 170 is an interleaf film, the surface protection film 170 functions as a separator and takes the place of separator 130.

Examples of surface protection films that can be used with the implementations described herein include but are not limited to at least one or more of a lithium carbonate film; a lithium fluoride (LiF) film; a dielectric or ceramic film (e.g., oxides of titanium (Ti), aluminum (Al), niobium (Nb), tantalum (Ta), zirconium (Zr), or a combination thereof); one or more metal film(s) (e.g., tin (Sn), antimony (Sb), bismuth (Bi), gallium (Ga), germanium (Ge), copper films, silver films, gold films, or a combination thereof); a copper chalcogenide film (e.g., CuS, Cu₂Se, Cu₂S); a bismuth chalcogenide film (e.g., Bi₂Te₃, Bi₂Se₃); a tin chalcogenide film (e.g., SnTe, SnSe, SnSe₂, SnS), a gallium chalcogenide film (e.g., GaS, Ga₂S₃, GaSe, Ga₂Se₃, GaTe), a germanium chalcogenide film (GeTe, GeSe, GeS), an indium chalcogenide film (e.g., InS, In₆S₇, In₂S₃, InSe, InS₄Se₃, In₆Se₇, In₂Se₃, InTe, In₄Te₃, In₃Te₄, In₇Te₁₀, In₂Te₃, In₂Te₅), a silver chalcogenide film (Ag₂Se, Ag₂S, Ag₂Te), boron nitride, lithium nitrate, lithium borohydride, and a combination thereof; and a carbon-containing film. In some examples, the one or more surface protection film(s) are ion-conducting films. The ion conducting film can be a lithium-ion conducting ceramic or a lithium-ion conducting glass. The lithium-ion conducting material may be comprised of one or more of LiPON, doped variants of either crystalline or amorphous phases of Li₇La₃Zr₂O₁₂, doped anti-perovskite compositions, Li₂S—P₂S₅, Li₁₀GeP₂S₁₂, and Li₃PS₄, lithium phosphate glasses, (1-x)LiI-(x)Li₄SnS₄, xLiI-(1-x)Li₄SnS₄, mixed sulfide and oxide electrolytes (crystalline LLZO, amorphous (1-x)LiI-(x)Li₄SnS₄ mixture, and amorphous xLiI-(1-x)Li₄SnS₄) for example. In one implementation, x is between 0 and 1 (e.g., 0.1, 0.2, 0.3, 0.4, 0.5, 0.6, 0.7, 0.8, and 0.9). In some examples, the one or more surface protection film(s) are permeable to at least one of lithium ions and lithium atoms. The one or more surface protection film(s) 170 provide surface protection of the metal or metal alloy film, which allows for handling of the metal or metal alloy film in a dry room. The surface protection film 170 can be formed by any suitable techniques including but not limited to vapor deposition techniques, dip-coating, slot-die coating, spray, doctor blade, gravure coating, printing, or any of a number of coating methods. In some implementations, the lithium-ion conducting material can be directly deposited on the lithium metal film using either a Physical Vapor Deposition (PVD) or Chemical Vapor Deposition (CVD) technique.

The positive electrode 120 or cathode may be any material compatible with the anode and may include an intercalation compound, an insertion compound, or an electrochemically active polymer. Suitable intercalation materials include, for example, sulfur, lithium-containing metal oxides, MoS₂, FeS₂, MnO₂, TiS₂, NbSe₃, LiCoO₂, LiNiO₂, LiMnO₂, LiMn₂O₄, V₆O₁₃ and V₂O₅. Suitable polymers include, for example, polyacetylene, polypyrrole, polyaniline, and polythiophene. In some implementations the positive electrode 120 includes a polymer binder material as described herein. The positive electrode 120 or cathode may be made from a layered oxide, such as lithium cobalt oxide, an olivine, such as lithium iron phosphate, or a spinel, such as lithium manganese oxide. Exemplary lithium-containing oxides may be layered, such as lithium cobalt oxide (LiCoO₂), or mixed metal oxides, such as LiNiₓCo₁₋₂ₓMnO₂, LiNiMnCoO₂ (“NMC”), LiNi_{0.5}Mn_{1.5}O₄, Li(Ni_{0.8}Co_{0.15}Al_{0.05})O₂, LiMn₂O₄, and doped lithium rich layered-layered materials, wherein x is zero or a non-zero number. Exemplary phosphates may be iron olivine (LiFePO₄) and it is variants (such as LiFe₍₁₋ₓ₎MgₓPO₄), LiMoPO₄, LiCoPO₄, LiNiPO₄, Li₃V₂(PO₄)₃, LiVOPO₄, LiMP₂O₇, or LiFe_{1.5}P₂O₇, wherein x is zero or a non-zero number. Exemplary fluorophosphates may be LiVPO₄F, LiAlPO₄F, Li₅V(PO₄)₂F₂, Li₅Cr(PO₄)₂F₂, Li₂CoPO₄F, or Li₂NiPO₄F. Exemplary silicates may be Li₂FeSiO₄, Li₂MnSiO₄, or Li₂VOSiO₄. An exemplary non-lithium compound is Na₅V₂(PO₄)₂F₃.

In some implementations of a lithium-ion cell according to the present disclosure, lithium is contained in atomic layers of crystal structures of carbon graphite (LiC₆) at the negative electrode and lithium manganese oxide (LiMnO₄) or lithium cobalt oxide (LiCoO₂) at the positive electrode, for example, although in some implementations the negative electrode may also include lithium absorbing materials such as silicon, tin, etc. The cell, even though shown as a planar structure, may also be formed into a cylinder by reeling the stack of layers; furthermore, other cell configurations (e.g., prismatic cells, button cells) may be formed.

Electrolytes infused in cell components 120, 130, 140, 145 and 170 can be comprised of a liquid/gel or a solid polymer and may be different in each. In some implementations, the electrolyte primarily includes a salt and a medium (e.g., in a liquid electrolyte, the medium may be referred to as a solvent; in a gel electrolyte, the medium may be a polymer matrix). The salt may be a lithium salt. The lithium salt may include, for example, LiPF₆, LiAsF₆, LiCF₃SO₃, LiN(CF₃SO₃)₃, LiBF₆, and LiClO₄, BETTE electrolyte (commercially available from 3M Corp. of Minneapolis, Minn.) and combinations thereof. Solvents may include, for example, ethylene carbonate (EC), propylene carbonate (PC), EC/PC, 2-MeTHF(2-methyltetrahydrofuran)/EC/PC, EC/DMC (dimethyl carbonate), EC/DME (dimethyl ethane), EC/DEC (diethyl carbonate), EC/EMC (ethyl methyl carbonate), EC/EMC/DMC/DEC, EC/EMC/DMC/DEC/PE, PC/DME, and DME/PC. Polymer matrices may include, for example, PVDF (polyvinylidene fluoride), PVDF:THF (PVDF:tetrahydrofuran), PVDF:CTFE (PVDF: chlorotrifluoroethylene) PAN (polyacrylonitrile), and PEO (polyethylene oxide).

FIG. 1B illustrates an example of a negative electrode cell 160 that can be combined with a positive electrode cell to form a lithium-ion energy storage device. The negative electrode cell 160 has a lithium metal film 145a, 145b with a surface protection film 170a, 170b formed thereon according to implementations of the present disclosure. The lithium metal film 145a, 145b may be a thin lithium metal film (e.g., 20 microns or less, from about 1 micron to about 20 microns, from about 2 microns to about 10 microns). The lithium metal film 145a, 145b can be a composite lithium metal film formed according to implementations of the present disclosure. The surface protection film 170a, 170b may be an interleaf film or ion-conducting polymer film as described herein. In some implementations where surface protection film 170a, 170b is an interleaf film, the interleaf film is typically removed prior to combining the negative electrode cell 160 with a positive electrode cell to form a lithium-ion storage device. In some implementations where surface protection film 170a, 170b is an ion-conducting polymer film, the ion-conducting polymer film is incorporated into the final battery structure.

The negative electrode cell 160 has a negative current collector 150, a negative electrode 140a, 140b formed on opposing sides of the negative current collector 150, lithium metal film 145a, 145b formed on the negative electrode 140a, 140b, and surface protection film 170a, 170b formed on the lithium metal film 145a, 145b. The negative electrode 140 can be a composite electrode as described herein. Although the negative electrode cell 160 is depicted as a dual-sided cell, it should be understood that the implementations described herein also apply to single-sided cells.

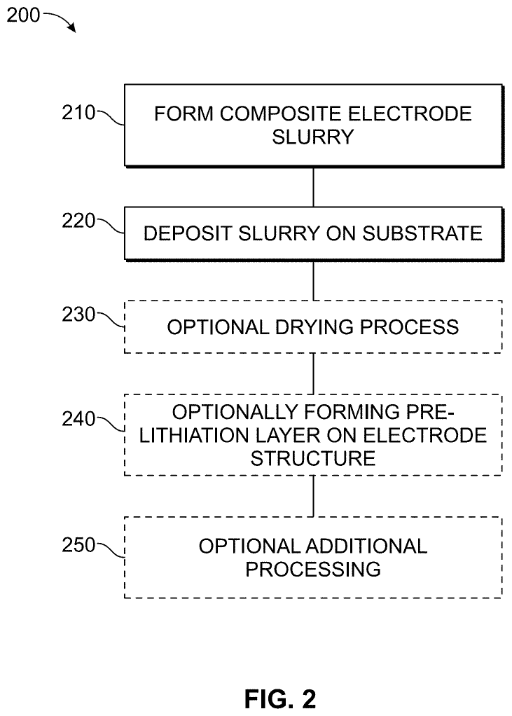

FIG. 2 illustrates a process flow chart summarizing one implementation of a method 200 for forming a composite electrode structure according to implementations described herein. In some implementations, the electrode structure formed by method 200 is the negative electrode structure 112 depicted in FIG. 1A.

At operation 210, a composite electrode slurry is formed. In some implementations, a given amount of a polyamic precursor was dissolved in a specific amount of water to form solution. The solution can be a homogeneous and viscous solution. One or more active materials were added to the solution. Examples of the one or more active materials include SiOx, silicon, graphite, or a combination thereof. One or more conductive additives were added to the solution. Examples of the one or more conductive additives include carbon black, acetylene black, or a combination thereof. The active material and the conductive added can be added sequentially or simultaneously to form a slurry. The active material and the conductive additive can be ground for a period of time at room temperature.

Examples of the polyamic precursor include:

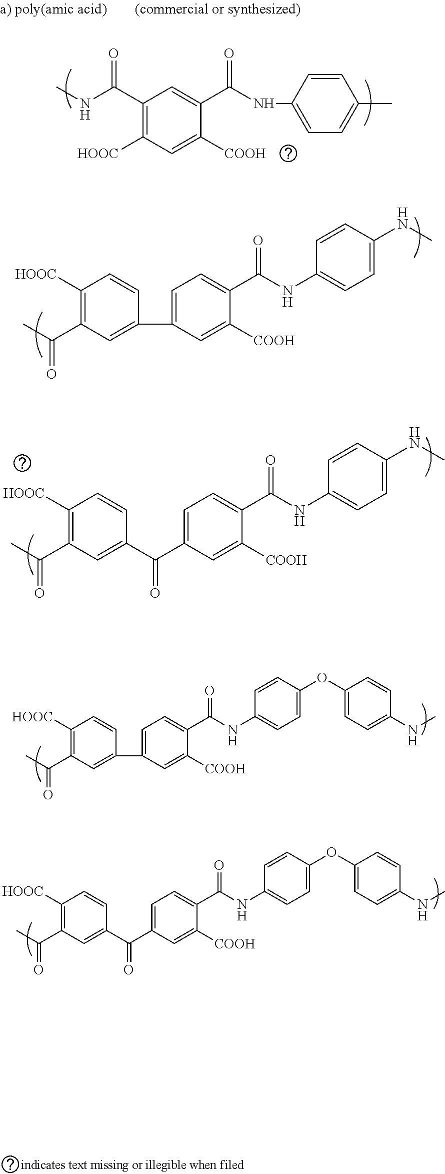

Examples of the polyamic precursor further include:

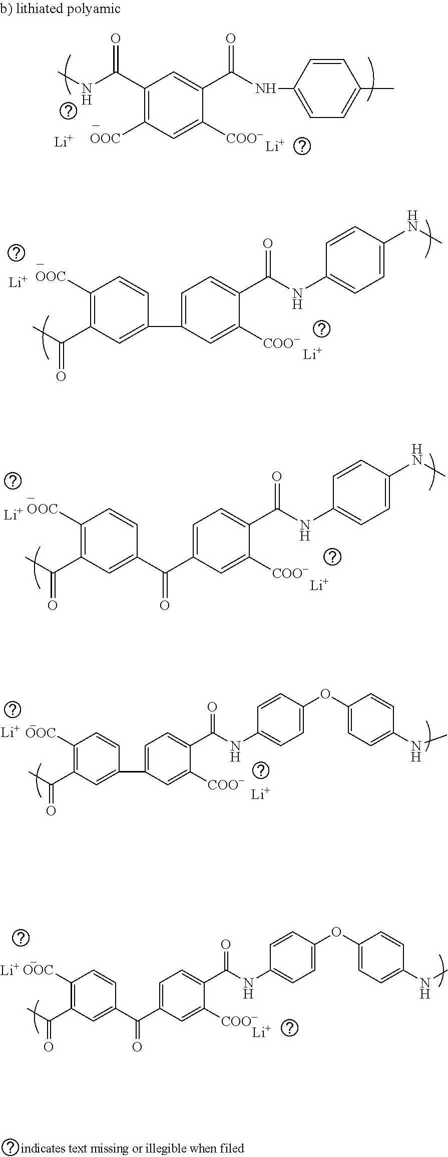

Examples of the polyimide resulting from the polyamic precursor include:

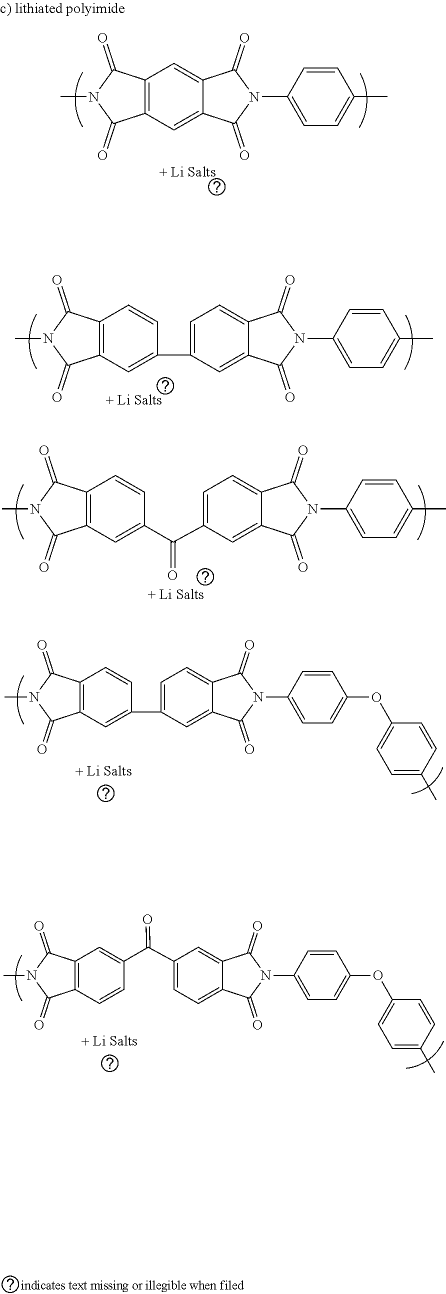

In some implementations, the polyamic precursor is present in an amount of about 1 wt. % to about 30 wt. % of the total weight of the slurry (e.g., an amount of about 5 wt. % to about 15 wt. % of the total weight of the slurry; or an amount of about 10 wt. % to about 15 wt. % of the total weight of the slurry). The polyamic precursor can be present in an amount of about 1 wt. %, about 2 wt. %, about 5 wt. %, about 10 wt. %, about 12 wt. %, about 14 wt. %, about 16 wt. %, about 18 wt, %, about 20 wt. %, about 22 wt. %, about 24 wt, %, about 26 wt. %, about 28 wt. %, about 30 wt. %, or any range between any two of these values of the total weight of the binder suspension or slurry.

In some implementations, the active material is an anode active material. The anode active material includes a material that reversibly intercalates/deintercalates lithium ions, a lithium metal, a lithium metal alloy, a material capable of doping and dedoping lithium, or a transition metal oxide.

The material that reversibly intercalates/deintercalates lithium ions is a carbon material, and may be any generally-used carbon-based anode active material in a lithium ion secondary battery, and examples thereof may be crystalline carbon, amorphous carbon, or a combination thereof. Examples of the crystalline carbon may be a graphite such as a unspecified shape, sheet-shaped, flake, spherical shaped or fiber-shaped natural graphite or artificial graphite, and examples of the amorphous carbon may be soft carbon or hard carbon, a mesophase pitch carbonized product, fired cokes, and the like.

The lithium metal alloy may include an alloy of lithium and a metal selected from the group consisting of Na, K, Rb, Cs, Fr, Be, Mg, Ca, Sr, Si, Sb, Pb, In, Zn, Ba, Ra, Ge, Al, Ag, and Sn.

The material capable of doping and dedoping lithium may be Si, SiOx (0<x<2), a Si-Q alloy (wherein Q is an element selected from the group consisting of an alkali metal, an alkaline-earth metal, a Group 13 element, a Group 14 element, a Group 15 element, a Group 16 element, a transition element, a rare earth element, and a combination thereof, and not Si), Sn, SnO₂, a Sn—R alloy (wherein R is an element selected from the group consisting of an alkali metal, an alkaline-earth metal, a Group 13 element, a Group 14 element, a Group 15 element, a Group 16 element, a transition element, a rare earth element, and a combination thereof, and not Sn), and the like, and at least one thereof may be mixed with SiO.sub.2. The elements Q and R may be selected from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The transition metal oxide may be vanadium oxide, lithium vanadium oxide, or lithium titanium oxide.

In some implementations, the active material is a cathode active material.

In some implementations, the active material is present in an amount of about 70 wt. % to about 98 wt. % of the total weight of the slurry (e.g., an amount of about 75 wt. % to about 90 wt. % of the total weight of the slurry; or an amount of about 80 wt. % to about 90 wt. % of the total weight of the slurry). The active material can be present in an amount of about 70 wt. %, about 72 wt. %, about 75 wt. %, about 80 wt. %, about 82 wt. %, about 84 wt. %, about 86 wt. %, about 88 wt. %, about 90 wt. %, about 92 wt. %, about 94 wt. %, about 96 wt. %, about 98 wt. %, or any range between any two of these values of the total weight of the binder suspension or slurry.

Examples of the conductive additive include a carbon-based material such as natural graphite, artificial graphite, carbon black, acetylene black, ketjen black, a carbon fiber, and the like; a metal-based material of a metal powder or a metal fiber including tin, copper, nickel, aluminum, silver, and the like; a conductive polymer such as a polyphenylene derivative; or a mixture thereof.

In some implementations, the conductive additives is present in an amount of about 1 wt. % to about 10 wt. % of the total weight of the slurry (e.g., an amount of about 1 wt. % to about 7 wt. % of the total weight of the slurry; or an amount of about 3 wt. % to about 5 wt. % of the total weight of the slurry). The conductive additives can be present in an amount of about 1 wt. %, about 2 wt. %, about 3 wt. %, about 4 wt. %, about 10 wt, %, or any range between any two of these values of the total weight of the binder suspension or slurry.

In some implementations, a cellulose-based compound may be further added to the slurry to provide viscosity as a thickener. The cellulose-based compound includes one or more of carboxylmethyl cellulose, hydroxypropylmethyl cellulose, methyl cellulose, or alkali metal salts thereof. The alkali metal may be Na, K, or Li. Such a thickener may be included in an amount of 0.1 parts by weight to 3 parts by weight based on 100 parts by weight of the anode active material.

At operation 220, the slurry is deposited on a substrate to form a film on the surface of the substrate. In one implementation, the slurry is deposited using a doctor blade process, dip coating process, slot-die coating process, and/or gravure coating process. In some implementations, the slurry is mixed to provide a homogenous mixture. In some implementations, the slurry is constantly mixed prior to deposition on the substrate. In some implementations, a distance between where the binder suspension or slurry is released from the deposition mechanism and the surface of the substrate where the slurry is deposited is greater than 100 μm (e.g., from about 100 μm to about 500 μm; from about 100 μm to about 300 μm; or from about 200 μm to about 400 μm).

At operation 230, optionally, the film is exposed to a drying process. The film may be exposed to the drying process to remove any solvents remaining from the binder solution and/or deposition process. In one implementation, the drying process evaporates any remaining water from the electrode structure. The drying process may comprise, but is not limited to, drying processes such as an air-drying process, for example, exposing the porous layer to heated nitrogen, an infrared drying process, or an annealing process.

At operation 240, optionally, a pre-lithiation layer can be formed on the surface of the electrode structure. The pre-lithiation layer can be the lithium metal film 145 formed on the surface of a negative electrode, for example, the negative electrode 140. The pre-lithiation layer can be a lithium metal film formed on the surface of a positive electrode, for example, the positive electrode 120. In some implementations, the surface treatment process of operation 220 activates the surface of the electrode structure improving the wettability of the subsequently deposited pre-lithiation layer formed during operation 230. The pre-lithiation process of operation 230 can be performed in a vacuum environment. The lithium metal film replenishes lithium lost from first cycle capacity loss of the electrode structure. The lithium metal film can be a thin lithium metal film (e.g., 20 microns or less, from about 1 micron to about 20 microns, from about 2 microns to about 10 microns). The lithium metal film can be deposited using vapor deposition techniques. For example, the lithium metal film 145 can be deposited by PVD techniques, for example, thermal evaporation techniques or electron beam evaporation techniques. The heat produced from the pre-lithiation process can in-situ convert the polyamic binder in the electrode structure (partially or fully depending on the process temperature) to polyimide. The prelithiation process by vapor deposition of lithium usually generates heat, which can be directly taken by the polyamic binder to form thermally stable polyimide.

At operation 250, the pre-lithiated electrode structure can be exposed to additional processing. For example, the formation of a lithium-ion conducting layer and/or surface protection layer over the pre-lithiated electrode structure.

Optionally, after formation of the electrode structure, a battery may be formed by combining the electrode structure with a separator and a cathode structure. A lithium-ion battery with an electrode structure according to implementations of the present disclosure may be combined with a positive electrode structure, separator and current collectors to form a battery such as the Li-ion energy storage device 100 schematically shown in FIG. 1A. The integration of the electrode structure with the other battery components may occur in the same manufacturing facility used for fabricating the electrode structure, or the electrode structure may be shipped on and integration may occur elsewhere.

In some implementations, the process of fabricating a battery proceeds generally as follows: separator, negative electrode structure and positive electrode structure are provided; the separator, negative electrode structure and positive electrode structure are individually cut into sheets of the desired size for a cell; tabs are added to the cut sheets of positive and negative electrode structures; the cut sheets of positive and negative electrode structures and separators are combined to form battery cells; battery cells may be wound or stacked to form the desired battery cell configuration; after the winding or stacking, the battery cells are placed in cans, the cans are evacuated, filled with electrolyte and then sealed.

### EXAMPLES

The following non-limiting examples are provided to further illustrate implementations described herein. However, the examples are not intended to be all inclusive and are not intended to limit the scope of the implementations described herein.

### Example 1

Electrode fabrication: electrode laminates are made with water-soluble polyamic binders (FIG. 3B) and active anode materials (e.g., SiOₓ, graphite) in a water-based slurry.

SiOₓ composite electrodes. A given amount of polyamic precursor was dissolved in specific amount of water to form a homogeneous and viscous solution. SiOₓ (active material) and graphite and acetylene black, commercially available as DENKA BLACK were sequentially added and thoroughly ground for 30 minutes at room temperature to form a slurry. The weight ratios of the polyamic precursor, SiOₓ, graphite, and DENKA BLACK were 15%, 60%, 20%, and 5% respectively. The slurry was coated on a copper foil using a doctor blade (˜200 μm), and the coated electrode was then dried at elevated temperatures in a vacuum oven, resulting in an area capacity of above 2.5 mAh/cm².

Graphite electrodes. A given amount of polyamic precursor was dissolved in specific amount of water to form a homogeneous and viscous solution. Graphite commercially available from Hitachi and DENKA BLACK were sequentially added and thoroughly ground for 30 minutes under room temperature. The weight ratios of polyamic precursor, graphite, and DENKA BLACK were 7%, 90%, and 3% respectively. The slurry was coated on a copper foil by using a doctor blade (˜200 μm), and the coated electrode was then dried at elevated temperatures in the vacuum oven.

Binder electrodes (specifically used for cyclic voltammetry study to understand the stability of polymer binder towards lithiation/dilithiation). A given amount of polyamic precursor was dissolved in specific amount of water to form a homogeneous and viscous solution. DENKA BLACK was then added and thoroughly ground with the binder solution. The weight ratios of polymer binder and DENKA BLACK are 70% and 30% respectively. The slurry was coated on a copper foil by using a doctor blade (˜200 μm), and the coated electrode was then dried at elevated temperatures in the vacuum oven.

### Example 2

Process for fabricating coin cells: coin cell (CR2032, MTI Corp.) assembly was performed in an argon-filled glovebox. A 14.42 mm diameter disk was punched out from the laminate for cell assembly as a working electrode. Lithium chip (16.0 mm in diameter, MTI Corp.) was used as the counter electrode. 60 to 80 μL of 1.2 M LiPF₆ in EC/DEC=3/7 electrolyte (Gen 2) obtained from Argonne National Lab was used for all electrochemical tests. Celgard 2400 separator (1.7 cm in diameter) was placed between the working electrode and the counter electrode.

Process for testing coin cells: the coin cell cycling performance was evaluated in a thermal chamber at 30° C. with a MACCOR Series 4000 Battery Test System. The cut-off voltage of cell testing is between 1.0 V and 0.01 V for half-cell, assuming a theoretical capacity of 1,200 mAh/g for SiOₓ and 375 mAh/g for graphite. In a galvanostatically cycling test, the coin cell was first lithiated to 100 mV, then delithiated to 1 Vat a rate of C/10. The C rate was calculated based on the theoretical capacity of active material (e.g. SiOₓ or graphite) only. The specific capacity of the material was reported on the bases of the theoretical capacity and the amount of active materials.

### Example 3

This example is to demonstrate the thermomechanical property of polymer binders and composite electrodes. The surface images of composite electrodes were collected with SEM (JSM-7500F JOEL, Japan) under high vacuum and an accelerating voltage of 12 kV. The polyimide coating was expected to homogeneously cover the surface for all the particles. No polymer aggregate was observed in the SEM images for both silicon and carbon-based anodes, which indicates excellent coating behavior of polyimide binders.

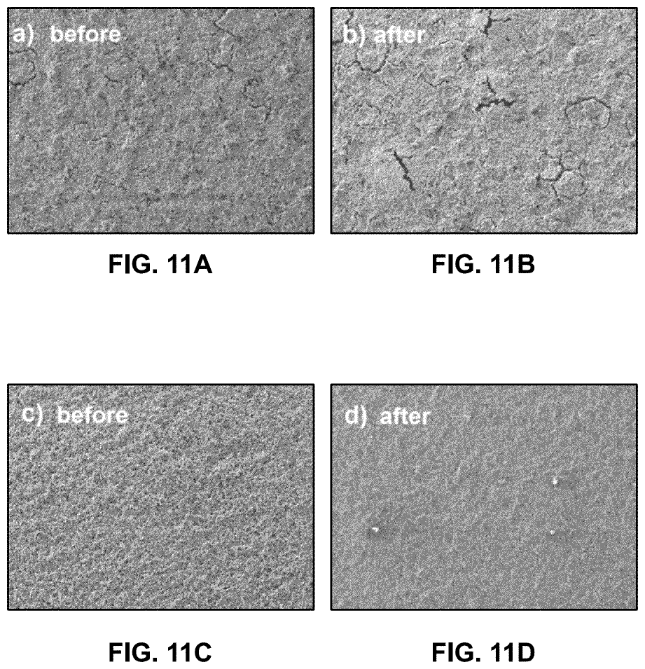

SEM was also applied to monitor any crack formation under mechanical bending. Typically, an electrode strap with a size of 1×3 cm was bent to 4.8 mm diameter and observed under SEM. For composite electrode with polyacrylic binder, it's well documented that the cracks form during drying and bending the electrodes due to the strong interaction of carboxylic acid groups with water as well as the mechanical brittleness of polyacrylics. While for electrodes with polyimide binder, no cracks were seen, which indicates the superior mechanical flexibility and binding property of polyimide binders (FIGS. 11A-11D).

### Example 4

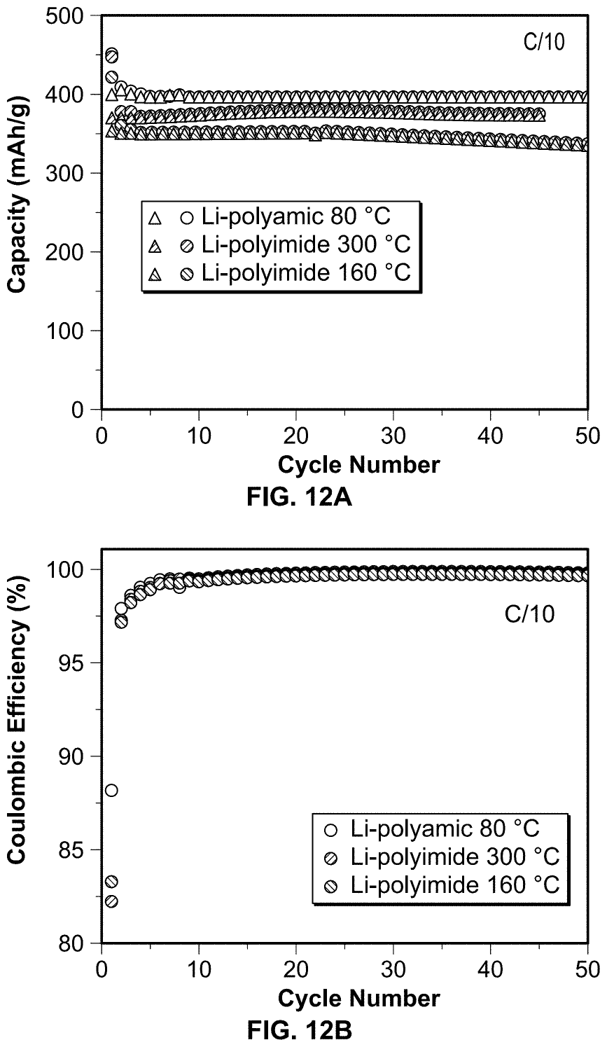

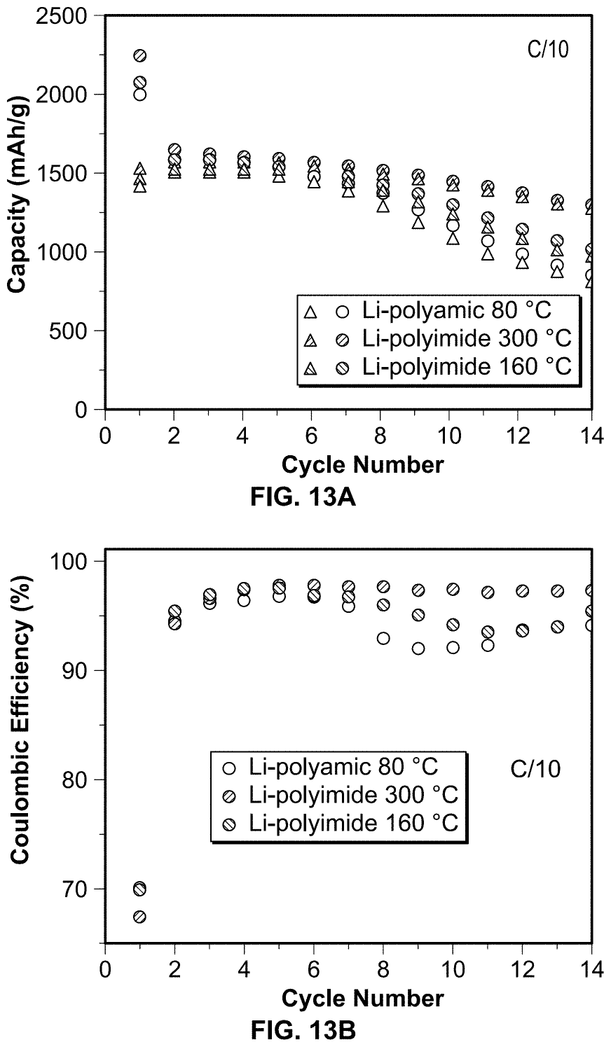

This example demonstrates the electrochemical property of graphite and SiOₓ composite electrodes. It's worth noting that the active material loading in the composite electrodes was high with an area capacity of ≥2.5 mAh/cm² in order to satisfy practical needs. FIGS. 12A-12B demonstrate the cycling performance of graphite electrodes with polyamic and polyimide binders. The half-cells exhibited remarkable cycling stability and high Coulombic efficiency for both polyamic and polyimide binders. Furthermore, for SiOₓ composite electrodes (FIGS. 13A-13B), polyimide (electrodes treated at 300° C.) demonstrate the best cycling stability and efficiency, possibly due to a better surface coating of polymer binder on active materials at higher temperature.

### Example 5

This example demonstrates the polyamic binder can be in-situ converted (partially or fully depends on manufacturing temperature) to polyimide with a high temperature process (FIG. 5). The prelithiation process by vapor deposition of lithium usually generates heat, which can be directly taken by the polyamic binder to form thermally stable polyimide.

Implementations of the present disclosure can include one or more of the following potential advantages. Implementations of the present disclosure include a water-soluble polyamic precursor design, which can function as both a synthetic binder and a precursor for polyimide binders with great thermal stability and mechanical flexibility. Furthermore, these polyimide binders can also accommodate new manufacturing processes that entail high thermal stability and mechanical flexibility. Benefiting from the unique properties of the class of polymers described herein, the resulting electrodes can be directly applied in high temperature processes and in-situ converted to highly stable polyimide by an endo-thermal reaction.

Implementations and all of the functional operations described in this specification can be implemented in digital electronic circuitry, or in computer software, firmware, or hardware, including the structural means disclosed in this specification and structural equivalents thereof, or in combinations of them. Implementations described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

Embodiments of the present disclosure further relate to any one or more of the following paragraphs:

1. A polymer binder comprising: amic acid groups and imide functionalities in a backbone of the polymer.

2. The polymer binder of paragraph 1, wherein the amic acid groups can be partially or fully reacted with lithium salts for water or organic based process.

3. The polymer binder of paragraph 1, wherein the amic acid groups can be partially or fully converted to an imide by a thermal process.

4. The polymer binder of paragraph 1, wherein a conversion of polyamic to polyimide can happen concurrently with a high temperature processes.

5. The polymer binder of paragraph 1, wherein the polymer binder is flexible.

6. The polymer binder of paragraph 1, wherein the polymer binder is lithiated.

7. The polymer binder of paragraph 1, wherein the polymer binder is strong.

8. A method to use and process polyamic and polyimide binder for anodes, comprising: thermally treating the polymer binder of any of paragraphs 1 to 7 for imidization, wherein the polymer binder is used as a binder for composite electrodes.

9. The method of paragraph 8, further comprising: fabricating a lithium-ion battery using the composite electrode.

10. A composite electrode, comprising: an active material; and the polymer binder of any of paragraphs 1 to 7.

11. The composite electrode of paragraph 10, wherein the composite electrode is tolerant to high temperature and mechanical bending.

12. The composite electrode of paragraph 10 or paragraph 11, wherein the thickness of the composite electrode is from about 1 μm to 100 μm.

13. A method of manufacturing an electrode, comprising: providing a polyamic precursor; exposing the polyamic precursor to a high temperature lithium deposition process to convert the polyamic precursor to a polyimide binder and form a composite electrode comprising the polyimide binder and lithium.

14. The method of paragraph 13, wherein the composite electrode further comprises an anode material comprising silicon and/or carbon.

15. The method of paragraph 13, wherein the polyamic precursor is water-soluble.

16. The method of paragraph 13, wherein the polyamic precursor is lithiated.

17. The method of paragraph 13, wherein the polyamic precursor is selected from: at least one of:

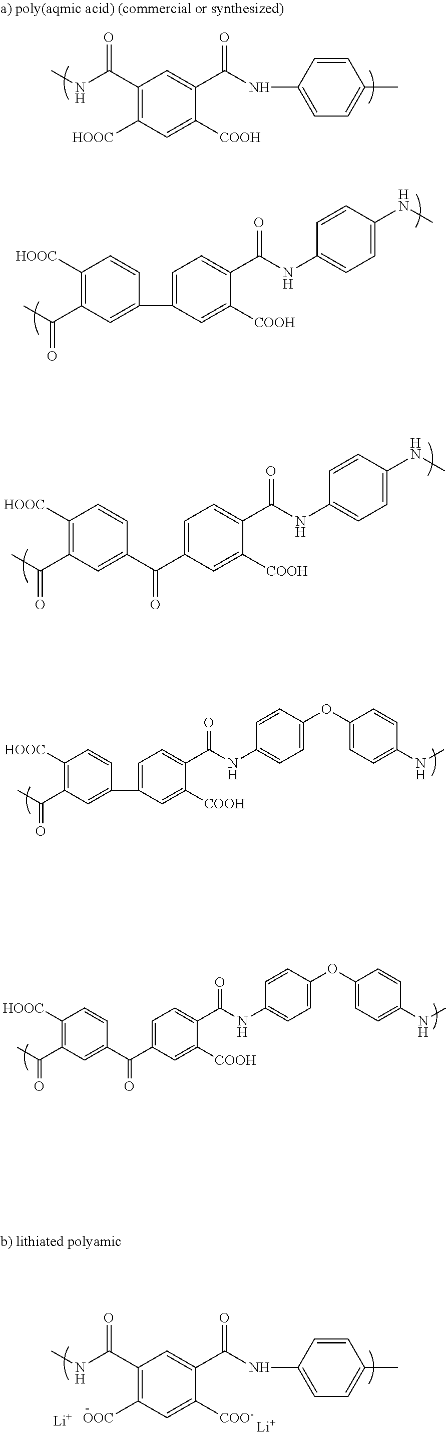

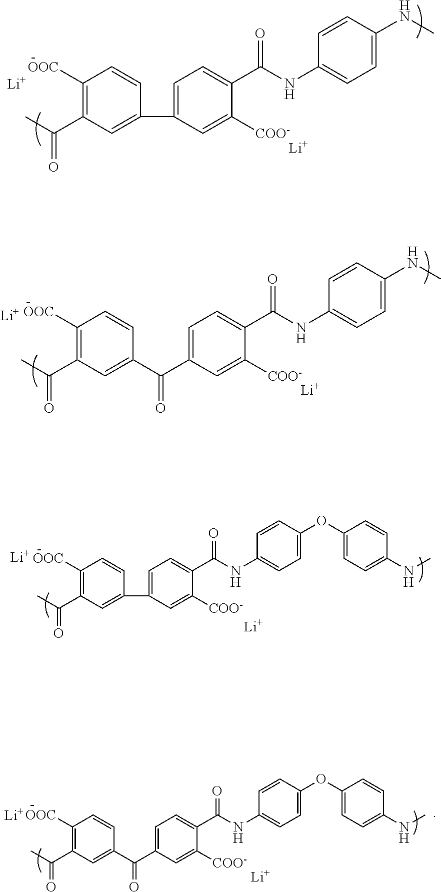

18. The method of paragraph 13, wherein the polyimide binder comprises a lithiated polyimide selected from: at least one of:

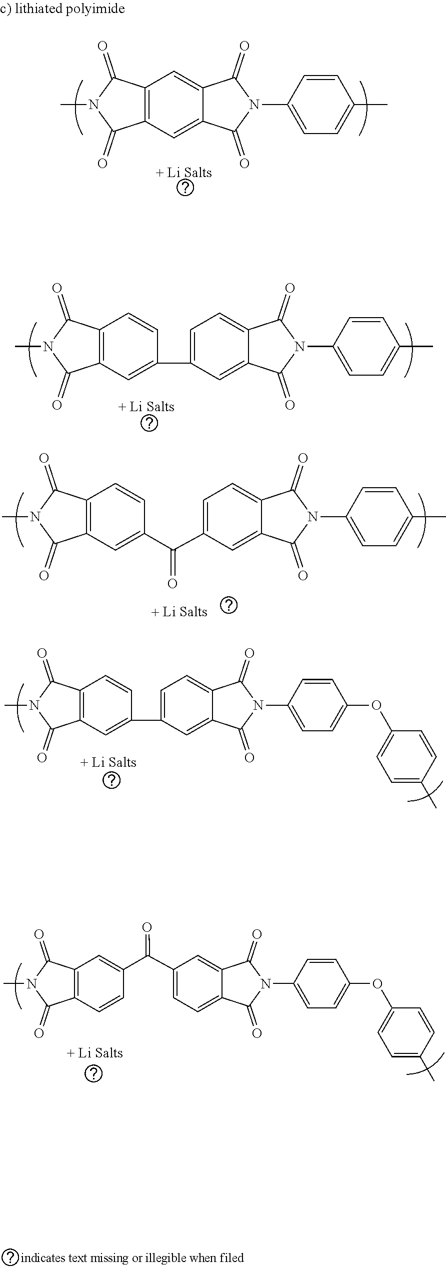

19. A method of forming an electrode structure, comprising: forming a slurry comprising a polyamic precursor and one or more anode active materials to form a slurry; depositing a thin film of the slurry on a substrate; and exposing the thin film and substrate to thermal processing to form the electrode structure.

20. The method of paragraph 19, wherein the thermal processing is selected from a thermal drying process, a vapor deposition process, or a combination thereof.

21. The method of paragraph 19, wherein the depositing a thin film comprises a slot-die coating process.

22. The method of paragraph 19, wherein the one or more anode active materials are selected from SiOx, silicon, graphite, or a combination thereof.

23. The method of paragraph 19, wherein the slurry further comprises a conductive additive selected from natural graphite, artificial graphite, carbon black, acetylene black, ketjen black, a carbon fiber, or a combination of.

24. The method of paragraph 19, wherein the thermal drying process evaporates the water from the electrode structure.

25. A method of forming a battery, comprising: combining the electrode structure of any of paragraphs 19 to 24 with a positive electrode structure, a first current collector contacting the positive electrode structure, a second current collector contacting the electrode structure and a separator positioned between the positive electrode structure and the negative electrode structure.

When introducing elements of the present disclosure or exemplary aspects or implementation(s) thereof, the articles “a,” “an,” “the” and “said” are intended to mean that there are one or more of the elements.

The terms “comprising,” “including” and “having” are intended to be inclusive and mean that there may be additional elements other than the listed elements.

While the foregoing is directed to embodiments of the present disclosure, other and further implementations of the disclosure may be devised without departing from the basic scope thereof, and the scope thereof is determined by the claims that follow.

1. A method of forming an electrode structure, comprising:
forming a slurry comprising a polyamic precursor and one or more anode active materials to form a slurry;
depositing a thin film of the slurry on a substrate; and
exposing the thin film and substrate to thermal processing to form the electrode structure.

2. The method of claim 1, wherein the thermal processing is selected from a thermal drying process, a vapor deposition process, or a combination thereof.

3. The method of claim 1, wherein the depositing a thin film comprises a slot-die coating process.

4. The method of claim 1, wherein the one or more anode active materials are selected from SiOx, silicon, graphite, or a combination thereof.

5. The method of claim 1, wherein the slurry further comprises a conductive additive selected from natural graphite, artificial graphite, carbon black, acetylene black, ketjen black, a carbon fiber, or a combination of.

6. The method of claim 1, wherein the polyamic precursor is selected from:
at least one of:

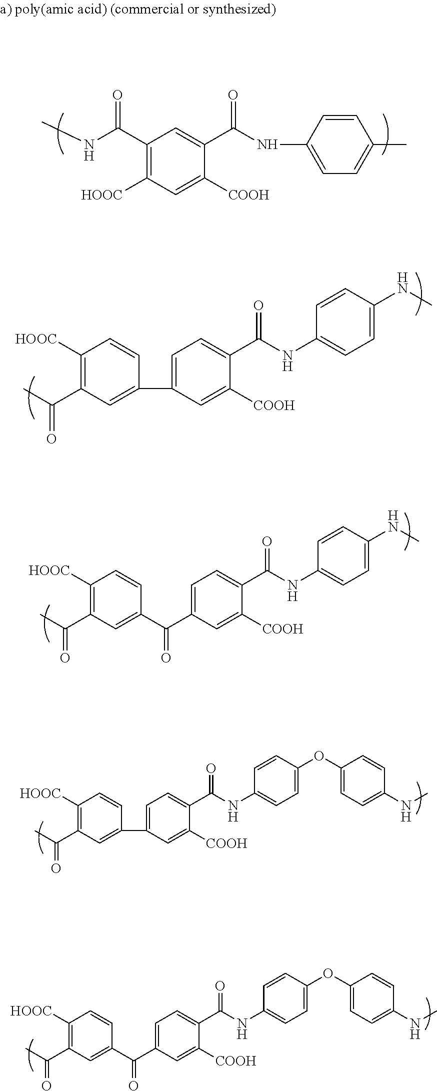

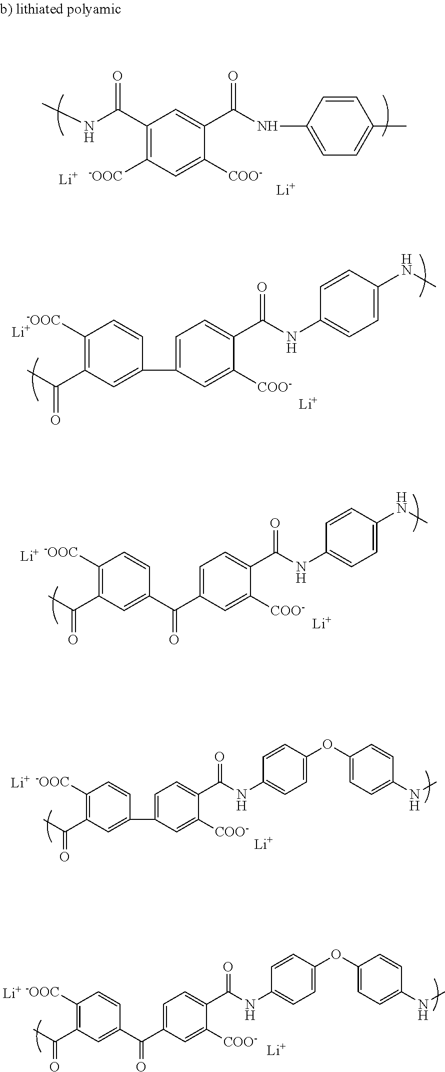

7. The method of claim 1, further comprising exposing the polyamic precursor to a high temperature lithium deposition process to convert the polyamic precursor to a polyimide binder and form a composite electrode comprising the polyimide binder and lithium.

8. The method of claim 7, wherein the polyimide binder comprises a lithiated polyimide selected from:
at least one of:

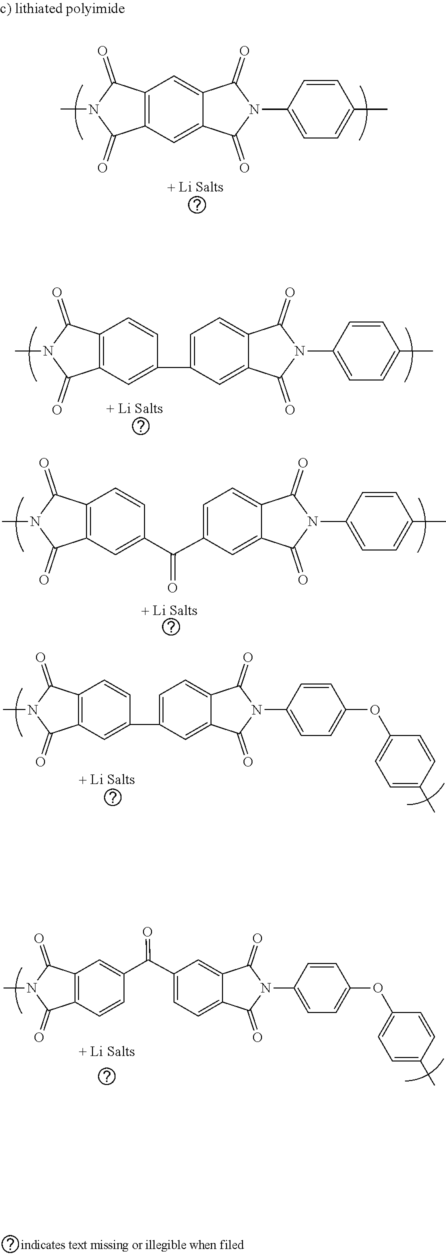

9. The method of claim 7, further comprising fabricating a lithium-ion battery using the composite electrode.

10. A method of forming a battery, comprising:
forming a slurry comprising a polyamic precursor and one or more anode active materials to form a slurry;
depositing a thin film of the slurry on a substrate;
exposing the thin film and substrate to thermal processing to form an electrode structure; and
combining the electrode structure with a positive electrode structure, a first current collector contacting the positive electrode structure, a second current collector contacting the electrode structure and a separator positioned between the positive electrode structure and a negative electrode structure.

11. The method of claim 10, further comprising exposing the polyamic precursor to a high temperature lithium deposition process to convert the polyamic precursor to a polyimide binder and form a composite electrode comprising the polyimide binder and lithium.

12. An electrode structure, comprising:
a negative electrode including a polymer binder material;
a lithium metal film including a lithium source and the binder material, wherein the polymer binder material includes at least one of:
a polyamic precursor binder, wherein the polyamic precursor binder is soluable; and
a polyimide binder; and
a negative current collector.

13. The electrode structure of claim 12, further comprising a surface protection film formed on the lithium metal film.

14. The electrode structure of claim 13, wherein the surface protection film includes a plurality of nano-pores that are sized to have an average pore size or diameter less than about 10 nanometers.

15. The electrode structure of claim 12, wherein the polyamic precursor binder is selected from:
at least one of:

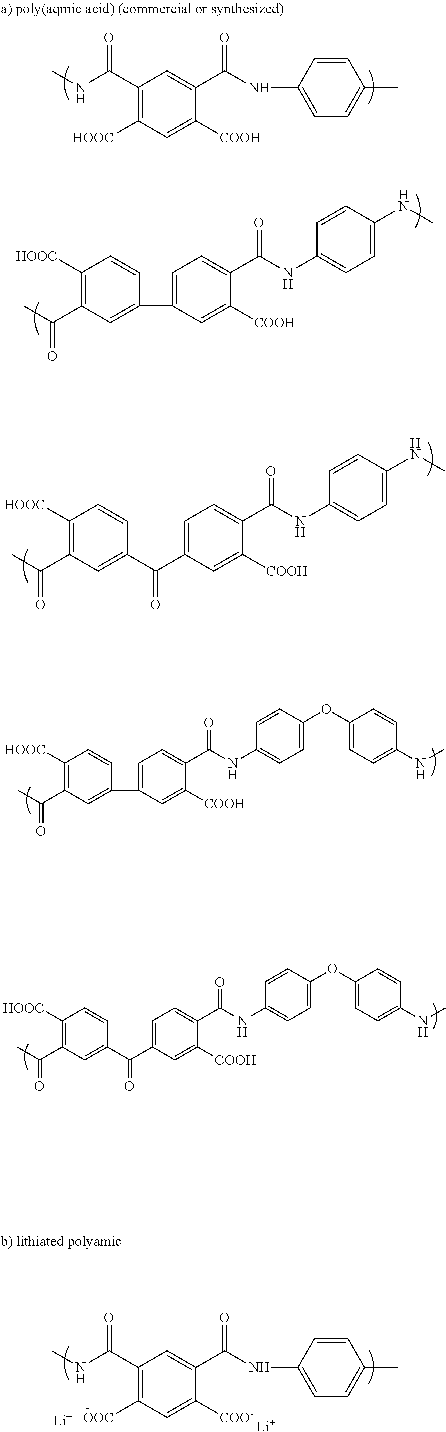

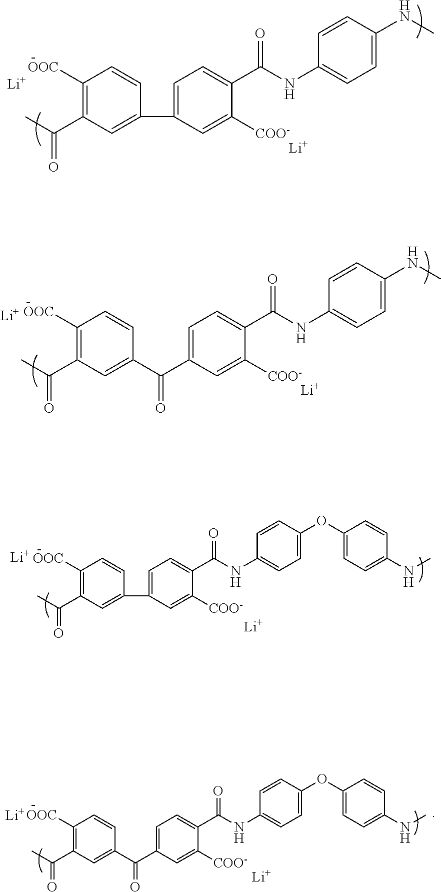

16. The electrode structure of claim 12, wherein the polyimide binder comprises a lithiated polyimide selected from:
at least one of:

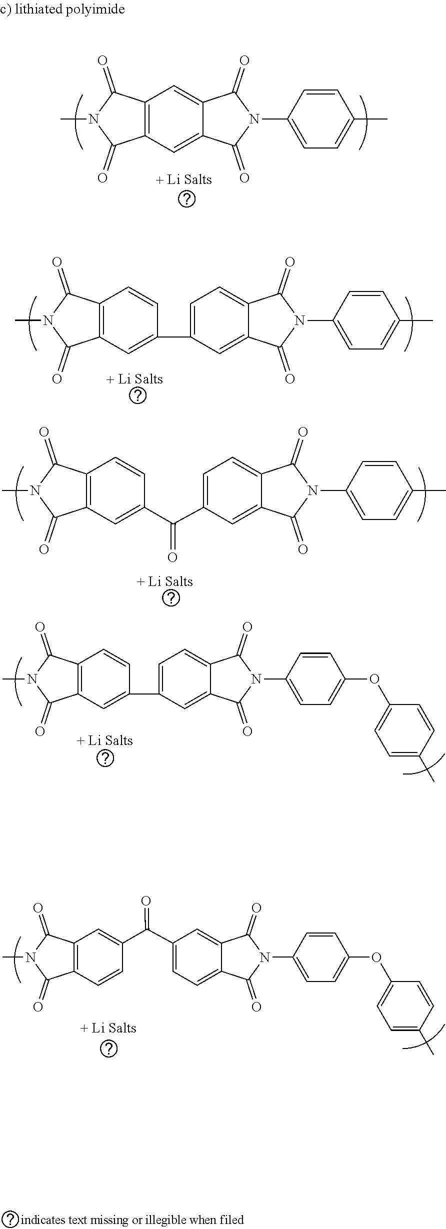

17. The electrode structure of claim 12, wherein the negative current collector includes one of aluminum (Al), copper (Cu), zinc (Zn), nickel (Ni), cobalt (Co), tin (Sn), silicon (Si), manganese (Mn), magnesium (Mg), alloys thereof, and combinations thereof.

18. The electrode structure of claim 12, wherein the polymer binder material includes amic acid groups and imide functionalities in a backbone of the polymer binder material.

19. The electrode structure of claim 12, wherein the polymer binder material is lithiated.

20. The electrode structure of claim 12, wherein the negative electrode is a silicon graphite or graphite composite anode with the lithium metal film formed thereon.
